(19) United States
(12) Patent Application Publication
(10) Pub. No.: US 2014/0122600 A1
(43) Pub. Date: May 1, 2014

(54) CONFERENCE SERVER IN A SYSTEM FOR PROVIDING A CONFERENCE SERVICE IN RTCWEB

(71) Applicant: Foundation of Soongsil University-Industry Cooperation, Seoul (KR)

(72) Inventors: Young-Han Kim, Seoul (KR); Hoanh Huu Tho Le, Seoul (KR)

(73) Assignee: Foundation of Soongsil University-Industry Cooperation, Seoul (KR)

(21) Appl. No.: 14/065,121

(22) Filed: Oct. 28, 2013

Related U.S. Application Data
(60) Provisional application No. 61/720,203, filed on Oct. 30, 2012.

(30) Foreign Application Priority Data
Oct. 26, 2012 (KR) 10-2012-0119900
Oct. 17, 2013 (KR) 10-2013-0124195

(51) Int. Cl. H04L 29/06

(52) U.S. Cl. CPC H04L 65/403
USPC 709/204

(57) ABSTRACT

Disclosed is a conference server included in a system for providing a conference service in RTCWeb, where the system includes a first terminal that operates as a moderator of the conference service and a second terminal that operates as a participant of the conference service. The conference server includes a focus that performs communication between the first terminal and the second terminal; the first terminal includes a conference control server/client that controls a generating of the conference, an adding/removing of the second terminal to/from the conference service, and a changing of a moderator, and manages information of the second terminal; and the second terminal includes a conference control client that acquires information of the conference service and controls a participation/departure in/from the conference service. The focus of the conference server communicates with the conference control server/client of the first terminal to resolve a request of the second terminal.

### CROSS-REFERENCE TO RELATED APPLICATIONS

This application claims the benefit of U.S. Provisional Application No. 61/720,203, filed with the United States Patent and Trademark Office on Oct. 30, 2012, Korean Patent Application No. 10-2013-0124195, filed with the Korean Intellectual Property Office on Oct. 17, 2013, and Korean Patent Application No. 10-2012-0119900, filed with the Korean Intellectual Property Office on Oct. 26, 2012, the disclosures of which are incorporated herein by reference in their entirety.

### BACKGROUND

1. Technical Field

The embodiments of the present invention relate to a conference server that is included in a system for providing a conference service in RTCWeb (Real-Time Communication in WEB-browsers).

2. Description of the Related Art

The standard protocols for real-time multimedia communication in web browsers, for voice communication, video conferencing, etc., are being standardized by the RTCWeb (Real-Tire Communication in WEB-browsers) working group at the IETF (Internet Engineering Task Force). Whereas real-time multimedia communications in web browsers have previously been implemented by various developers according to their respective application programs using non-standardized methods, attempts to standardize the methods are being made by the W3C (World Wide Web Consortium) and the IETF.

The services being considered for standardization are basically real-time communication services between web browsers. Examples may include video conferencing, multi-user network games, etc., which utilize voice communication and image communication between different web browsers.

FIG. 1 illustrates the concept of an example of real-time communication in web browsers according to the related art.

Referring to FIG. 1, multimedia data such as voice data, images, etc., may be transmitted via a direct connection between web browsers. In contrast, the signal path for session connection between the web browsers can be implemented by way of a separate server such as a web server. Also, the signal protocol can use the conventional session initiation protocol (SIP) as well as various other protocols such as XMPP (Extensible Messaging and Presence Protocol), etc.

If it is possible to connect signal protocols of various forms other than this model, it may be critically required in the standard that a standardized method, such as for media compatibility, etc., be established beforehand for the media path based on a direct connection between web browsers.

Also, either a standards-based or a proprietary protocol may be used between the browser and the web server. For the application brought to the web browser, it is sufficient that the application operate through the API (application program interface) in the standards-based web browser. The application can take various forms, such as Javascript, HTML, etc., and the W3C and its WebRTC working group (Web Applications and Device API) are currently developing standards for the API in an HTML5-based web browser for Javascript.

However, RTCWeb has its unique characteristics, and a suitable architecture is needed in order to provide a conference service in RTCWeb using such characteristics.

### SUMMARY

To resolve the problem above, an aspect of the invention aims to propose a conference server that is to be included in a system for providing a conference service in RTCWeb (Real-Time Communication in WEB-browsers).

To achieve the objective above, an embodiment of the invention provides a conference server included in a system for providing a conference service in RTCWeb, the system comprising a first terminal and a second terminal, the first terminal operating as a moderator of the conference service and having a web browser executed thereon, the second terminal operating as a participant of the conference service and having a web browser executed thereon. The conference server includes a focus configured to perform communication between the first terminal and the second terminal; the first terminal includes a conference control server/client configured to control a generating of the conference, an adding/removing of the second terminal to/from the conference service, and a changing of a moderator, and configured to manage information of the second terminal; and the second terminal includes a conference control client configured to acquire information of the conference service and configured to control a participation/departure in/from the conference service. The focus of the conference server communicates with the conference control server/client of the first terminal to resolve a request of the second terminal.

The first terminal can further include a floor control server for controlling a floor of the conference by granting/revoking authorization to transmit a media stream; the second terminal can further include a floor control client configured to communicate with the floor control server of the first terminal and request authorization to transmit a media stream or disengage a set floor; and the conference server can further include a mixer configured to mix media streams transmitted by the first terminal and the second terminal and transmit the mixed media stream to the first terminal and the second terminal.

Each of the first terminal and the second terminal can further include a presence client configured to transmit presence information, and the conference server can further include a presence server configured to receive the presence information from each of the presence client of the first terminal and the presence client of the second terminal and to transmit the collected presence information to the presence client of the first, terminal and the presence client of the second terminal.

The conference server/client of the first terminal can transmit a conference generation request message to the focus of the conference server, where the conference generation request message contains information on a conference to be generated; the focus of the conference server can transmit a conference generation response message for a negotiation of the information on the conference to the conference control server/client of the first terminal based on the conference generation request message; and if the conference control server/client of the first terminal agrees to the negotiation of the information on the conference, the conference control server/client of the first terminal can transmit a negotiation agreement message for the conference generation to the focus of the conference server, and the focus of the conference server can generate the conference based on the negotiation agreement message for the conference generation.

The information on the conference can include at least one of identification information of the conference, the time at which the conference is generated, a time segment for informing that the second terminal can participate in the conference, the maximum number of second terminals that can participate in the conference, the number of second terminals participating in the conference, the maximum number of second terminals that can transmit media simultaneously, the number of second terminals transmitting media simultaneously, information on a predefined default presence, and a media codec.

From among the information on the conference, at least one of the time segment for informing availability for participating in the conference, the maximum number of second terminals that can participate in the conference, the maximum number of second terminals that can transmit media simultaneously, and the media codec can be information of which can be negotiated by the focus of the conference server and the conference control server/client of the first terminal.

The conference server can further include a notification server configured to notify information related to an event within the conference.

The conference control client of a second terminal not participating in the conference service can transmit a conference service participation request message to the focus of the conference server; the focus of the conference server can forward the conference service participation request message to the conference control server/client of the first terminal if a codec exists that is capable of providing support between the mixer of the conference server and the non-participating second terminal; the conference control server/client of the first terminal can add information of the non-participating second terminal to a participant list of the first terminal based on the conference service participation request message and can transmit a conference service participation acceptance message to the focus of the conference server; the focus of the conference server can add the information of the non-participating second terminal to a participant list of the conference server to change the non-participating second terminal to a participated second terminal in the conference service and can transmit the conference service participation acceptance message to the conference control client of the participated second terminal; and the notification server of the conference server can notify other second terminals already participating in the conference service with a message informing that a new participant (the participated second terminal) has been added.

The floor control client of the participated second terminal can perform a session negotiation with the mixer of the conference server, and after the session negotiation is performed, the floor control client of the participated second terminal can receive the mixed media stream from the mixer of the conference server.

The conference control client of a second terminal departing from the conference service can transmit a conference service departure request message to the focus of the conference server; the focus of the conference server can remove the departing second terminal from a participant list of the conference server based on the conference service departure request message and can transmit a conference service departure response message to the conference control client of the departing second terminal; the notification server of the conference server can notify the first terminal and other second terminals participating in the conference service with a message notifying that there is a departing participant (the departing second terminal); the conference control server/client of the first terminal can remove the departing second terminal from a participant list of the first terminal; and the conference control client of the other second terminal can remove the departing second terminal from a participant list of the other second terminals.

The floor control client of the departing second terminal, upon receiving the conference service departure response message, can conclude a peer connection with the mixer of the conference server for transmitting/receiving the media stream; and the mixer of the conference server can re-perform the session negotiation with the floor control server of the first terminal and the floor control client of the second terminal.

The floor control client of a second terminal transmitting a media stream can transmit a media stream transmission request message to the focus of the conference server; the focus of the conference server can forward the media stream transmission request message to the floor control server of the first terminal; the floor control server/client of the first terminal can transmit a media stream transmission response message to the focus of the conference server based on the media stream transmission request message; the focus of the conference server can forward the media stream transmission response message to the floor control client of the second terminal transmitting the media stream; the floor control client of the second terminal transmitting the media stream can transmit a media stream to the mixer of the conference server based on the media stream transmission response message; and the mixer of the conference server can further mix the media stream transmitted from the second terminal with the previously mixed media stream, and can perform a session re-negotiation with the first terminal and other second terminals participating in the conference service to transmit the further mixed media stream.

The system for providing a conference service in RTCWeb can change the moderator from the first terminal to a second terminal, which may operate as a new moderator, where the second terminal operating as the new moderator includes a conference control server/client and a floor control server; the conference control server/client of the first terminal can transmit a moderator change request message to the focus of the conference server; the notification server of the conference server can transmit a message informing that the moderator was changed to the second terminal operating as the new moderator; the conference control server/client of the second terminal operating as the new moderator can transmit a moderator change response message to the focus of the conference server based on the moderator change request message; the focus of the conference server can transmit the moderator change response message to the conference control server/client of the first terminal; the notification server of the conference server can inform others of the second terminals participating in the conference service with a message informing that the moderator has been changed; the conference control server/client of the second terminal operating as the new moderator can transmit a moderator participation request message for the conference service; the focus of the conference server can set the second terminal operating as the new moderator to be the changed moderator and can transmit a moderator participation response message for the conference service to the second terminal that is the changed moderator; the mixer of the conference server and the floor control server of the second terminal that is the changed moderator can perform a session negotiation; and the second terminal that is the changed moderator can transmit a message through the conference server to the first terminal, informing that the old moderator has departed.

Certain embodiments of the invention can provide a system for efficiently providing a conference service in RTCWeb.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates the concept of an example of real-time communication in web browsers according to the related art.

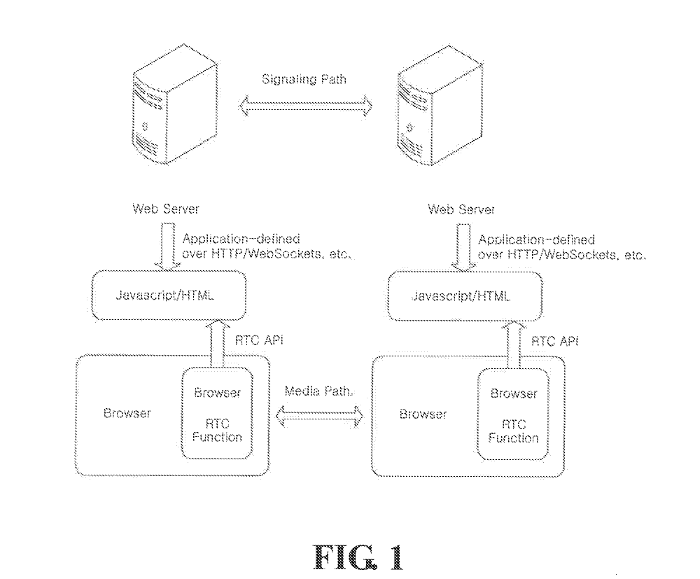

FIG. 2 illustrates a system for providing a conference service in RTCWeb according to an embodiment of the invention.

FIG. 3 is a flow diagram illustrating the flow of operations for generating a conference service in RTCWeb according to an embodiment of the invention.

FIG. 4 is a flow diagram illustrating the flow of operations by which a second terminal that was not participating in a conference service in RTCWeb joins the conference service according to an embodiment of the invention.

FIG. 5 is a flow diagram illustrating the flow of operations by which a second terminal participating in a conference service in RTCWeb departs from the conference service according to an embodiment of the invention.

FIG. 6 is a flow diagram illustrating the flow of operations by which a second terminal participating in a conference service in RTCWeb transmits a media stream according to an embodiment of the invention.

FIG. 7 is a flow diagram illustrating the flow of operations by which a first terminal participating in a conference service in RTCWeb changes the moderator.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements.

Certain embodiments of the invention will be described below in more detail with reference to the accompanying drawings.

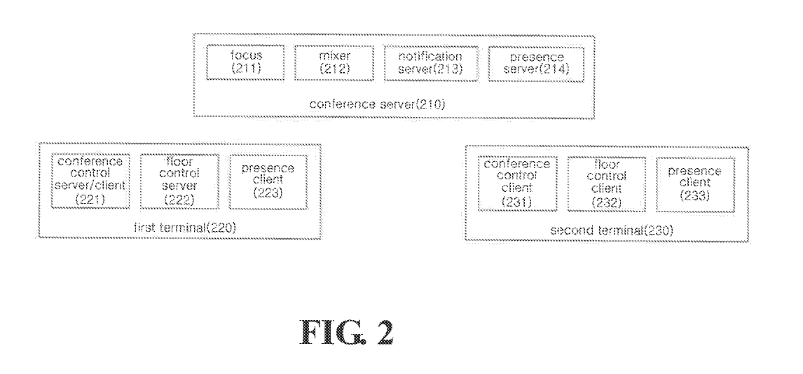

FIG. 2 illustrates a system for providing a conference service in RTCWeb (Real-Time Communication in WEB-browsers) according to an embodiment of the invention.

Referring to FIG. 2, a system 200 according to an embodiment of the invention may include a conference server 210, a first terminal 220, and at least one second terminal 230.

The conference server 210 may be a web server, while the first terminal 220 and the second terminal 230 may be terminal devices in which a web browser capable of supporting an RTCWeb function is executed. The first terminal 220 may operate as the moderator of a conference service, while the at least one second terminal 230 may operate as participants of the conference service. The first terminal 220 and the second terminal 230 may each communicate with the conference server 210 through a signaling channel.

Also, when application programs are running on the web browsers executed on the first terminal 220 and second terminal 230, the respective web browsers can change the user interface according to the roles in the conference without loading the application programs again. Thus, the users of the first terminal 220 and the second terminal 230 can easily generate or participate in a conference through the web browser, and can establish real-time multimedia communication session without using the resources of a third party.

Looking in more detail at the composition of the system 200 according to an embodiment of the invention, the conference server 210 may include a focus 211, a mixer 212, a notification server 213, and a presence server 214; the first terminal 220 may include a conference control server/client 221, a floor control server 222, and a presence client 223; and the second terminal 230 may include a conference control client 231, a floor control server 232, and a presence client 233.

To be more specific, the conference control server/client 221 of the first terminal 220 may include a focus (not shown) and a conference control client (not shown). The focus (not shown) of the first terminal 220 may play the role of a conference control server that manages the information and membership of the participants. The conference control client (not shown) of the first terminal 220 may communicate with the focus 211 of the conference server 210 and may control the generating of a conference, the adding/removing of the second terminal to/from the conference service, and the changing of the moderator. The conference control client 231 of the second terminal 230 may acquire information of the conference service and control the participation/departure in/from the conference service. The focus 211 of the conference server 210 may communicate with the conference control server/client 221 of the first terminal 220 to resolve the request of the second terminal 230.

The floor control server 222 of the first terminal 220 may control the floor and indicate the state of the floor. That is, the floor control server 222 of the first terminal 220 may control the floor of the conference by granting/revoking authorization to transmit a media stream. The floor control client 232 of the second terminal 230 may communicate with the floor control server 222 of the first terminal 220 and request authorization to transmit a media stream or disengage a set floor. The mixer 212 of the conference server 210 may the mix media streams transmitted by the first terminal 220 and the second terminal 230 and may transmit the mixed media stream to the first terminal 220 and the second terminal 230. Furthermore, the mixer 212 of the conference server 210 can upkeep/maintain the connections of all participants within the conference and can perform session negotiations, and functions related to transcoding may also be performed at the mixer 212.

The notification server 213 of the conference server 210 may notify information related to events within the conference. Also, the presence client 223, 233 of each of the first terminal 220 and the second terminal 230 may transmit presence information, and the presence server 214 of the conference server 210 may receive the presence information from each of the presence client 223 of the first terminal 220 and the presence client 233 of the second terminal 230 and may transmit the collected presence information to the presence client 223 of the first terminal 220 and the presence client 233 of the second terminal 230.

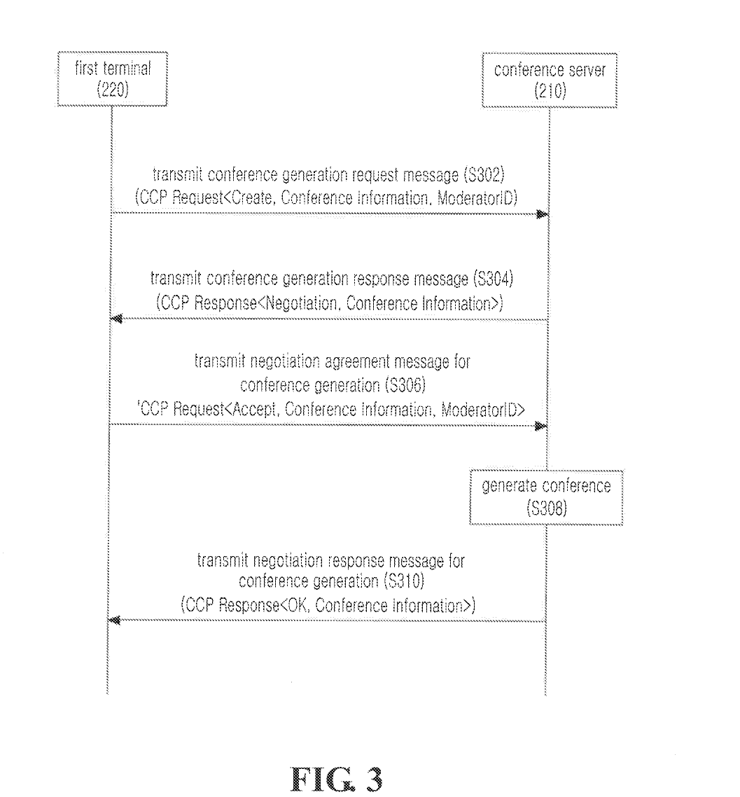

The operations for providing a conference service in RTCWeb will be described below in more detail with reference to FIG. 3 through FIG. 7.

FIG. 3 is a flow diagram illustrating the flow of operations for generating a conference service in RTCWeb according to an embodiment of the invention. The procedures performed for each operation will be described below in more detail.

First, in step S302, the conference server/client 221 of the first terminal 220 may transmit a conference generation request message, which contains information on a conference that is to be generated, to the focus 211 of the conference server 210. In one example, the conference generation request message can be a “CCP (Conference Control Protocol) Request”, and the message can include the purpose of the message (Create), information on the conference, and the identification information of the first terminal 220 operating as the moderator (ModeratorID) (CCP Request<Create, Conference Information, ModeratorID>).

According to an embodiment of the invention, the information on the conference can include at least one of the following nine types of information:

i) identification information of the conference,

ii) time at which the conference was generated,

iii) time segment for informing that at least one second terminal 230 can participate in the conference,

iv) maximum number of second terminals 230 that can participate in the conference,

v) number of second terminals 230 participating in the conference,

vi) maximum number of second terminals 230 that can transmit media simultaneously,

vii) number of second terminals 230 transmitting media simultaneously,

viii) information on a predefined default presence, and

ix) a media codec.

Next, in step S304, the focus 211 of the conference server 210 may transmit a conference generation response message, for negotiating the information on the conference, to the conference control server/client 221 of the first terminal 220 based on the conference generation request message. In one example, the conference generation response message can be a “CCP Response” message, and the message can include the purpose of the message (Negotiation) and information regarding the conference (CCP Response<Negotiation, Conference Information>).

According to an embodiment of the invention, from among the nine types of information regarding the conference, at least one of the time segment for informing availability for participating in the conference, the maximum number of second terminals 230 that can participate in the conference, the maximum number of second terminals 230 that can transmit media simultaneously, and the media codec can be information that can be negotiated by the focus 211 of the conference server 210 and the conference control server/client 221 of the first terminal 220. Thus, these four types of information can be included in the “conference information” within the conference generation response message.

Continuing with the description, in step S306, if the conference control server/client 221 of the first terminal 220 agrees to the negotiation of the information on the conference, the conference control server/client 221 of the first terminal 220 may transmit a negotiation agreement message for conference generation to the focus 211 of the conference server 210. In one example, the negotiation agreement message for conference generation can include the purpose of the message (Accept), the information on the conference, and the identification information of the moderator, to be “CCP Request<Accept, Conference Information, ModeratorID>”

Lastly, in step S308, the focus 211 of the conference server 210 may create the conference based on the negotiation agreement message for conference generation, and in step S310, the focus 211 of the conference server 210 may transmit a negotiation response message to the conference control server/client 221 of the first terminal 220. In one example, the negotiation response message can include the purpose of the message (OK), and the information on the conference, to be “CCP Response<OK, Conference Information>”.

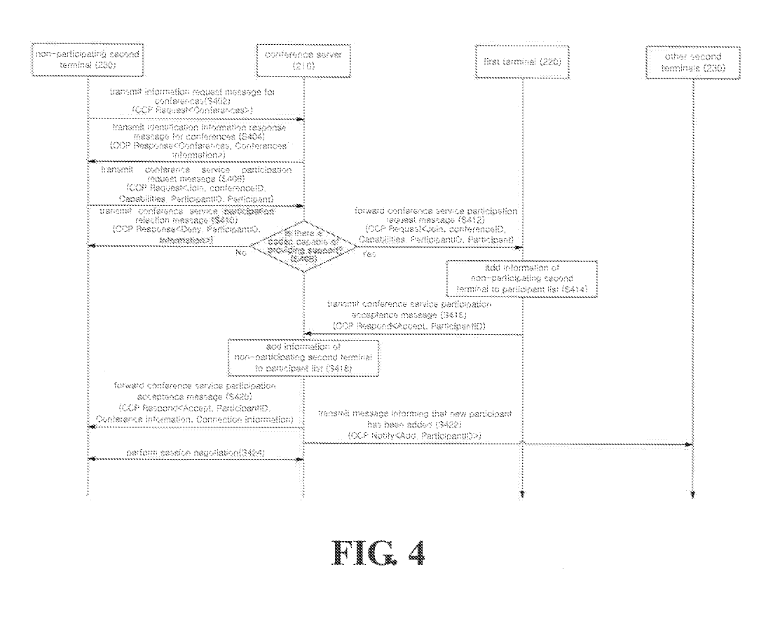

FIG. 4 is a flow diagram illustrating the flow of operations by which a second terminal 230 that was not participating in a conference service in RTCWeb joins the conference service according to an embodiment of the invention. The procedures performed for each operation will be described below in more detail.

First, if the non-participating second terminal 230 is unaware of what conferences have been created, in step S402, the non-participating second terminal 230 may transmit an information request message, for conferences that have been created, to the focus 211 of the conference server 210. In one example, the identification information request message for conferences can be “CCP Request<Conferences>”. Then, in step S404, the focus 211 of the conference server 210 may transmit an information response message for conferences that have been created to the non-participating second terminal 230. In one example, the identification information response message for conferences can be “CCP Response<Conferences, Conferences' Information>”. However, if the non-participating second terminal 230 is aware of information relating to conferences, step S402 and step S404 can be omitted.

Next, in step S406, the conference control client 231 of the non-participating second terminal 230 may transmit a conference service participation request message to the focus 211 of the conference server 210. In one example, the conference service participation request message can be “CCP Request<Join, conferenceID, Capabilities, ParticipantID, Participant>”. Then, in step S408, the focus 211 of the conference server 210 may determine whether a codec exists that is capable of providing support between the mixer 212 of the conference server 210 and the non-participating second terminal 230.

If there is no codec that is capable of providing support between the mixer 212 of the conference server 210 and the non-participating second terminal 230, then in step S410, the focus 211 of the conference server 210 may transmit a conference service participation rejection message to the conference control client 231 of the non-participating second terminal 230. In one example, the conference service participation rejection message can be “CCP Response<Deny, ParticipantID, Information>”. Conversely, if there is a codec that is capable of providing support between the mixer 212 of the conference server 210 and the non-participating second terminal 230, then in step S412, the focus 211 of the conference server 210 may forward the conference service participation request message to the conference control server/client 221 of the first terminal 220.

Continuing with the description, the conference control server/client 221 of the first terminal 220, in step S414, may add the information of the non-participating second terminal 230 to a participant list in the first terminal 220 based on the conference service participation request message, and in step S416, may transmit a conference service participation acceptance message to the focus 211 of the conference server 210. In one example, the conference service participation acceptance message can be “CCP Respond<Accept, ParticipantID>”.

Then, in step S418, the focus 211 of the conference server 210 may add the information of the non-participating second terminal to a participant list in the conference server 210 to change the non-participating second terminal 230 to a second terminal participated in the conference service. Then, in step S420, the focus 211 of the conference server 210 may forward the conference service participation acceptance message to the conference control client 231 of the participated second terminal 230. In one example, the forwarded conference service participation acceptance message can be “CCP Respond<Accept, ParticipantID, Conference Information, Connection information>”.

Also, in step S422, the notification server 213 of the conference server 210 may notify other second terminals 230 that are already participating in the conference service with a message informing that a new participant (the participated second terminal 230) has been added. In one example, the message informing that a new participant has been added can be “CCP Notify<Add, ParticipantID>”.

Next, in step S424, the floor control client 232 of the participated second terminal 230 may perform a session negotiation with the mixer 212 of the conference server 210. Thus, after the session negotiation is performed, the floor control client 232 of the participated second terminal 230 can receive the mixed media stream from the mixer 212 of the conference server 210.

In certain instances, the first terminal 220 that acts as the moderator can reject the participation request of the non-participating second terminal 230. In this case, the first terminal 220 can transmit a conference service participation rejection message through the conference server 210.

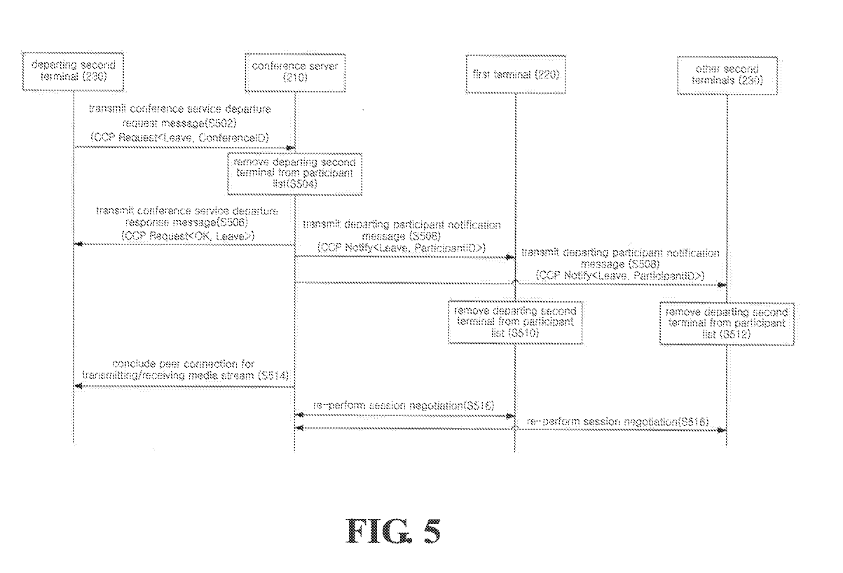

FIG. 5 is a flow diagram illustrating the flow of operations by which the second terminal 230 participating in a conference service in RTCWeb departs from the conference service according to an embodiment of the invention. The procedures performed for each operation will be described below in more detail.

First, in step S502, the conference control client 231 of the second terminal 230 departing from the conference service may transmit a conference service departure request message to the focus 211 of the conference server 210. In one example, the conference service departure request message can be “CCP Request<Leave, ConferenceID>”.

Next, the focus 211 of the conference server 210 in step S504 may remove the departing second terminal 230 from the participant list in the conference server 210 based on the conference service departure request message, and in step S506, may transmit a conference service departure response message to the conference control client 231 of the departing second terminal 230. In one example, the conference service departure response message can be “CCP Request<OK, Leave>”. Then, in step S508, the notification server 213 of the conference server 210 may notify the first terminal 220 and other second terminals 230 participating in the conference service with a message notifying that there is a departing participant (the departing second terminal 230). In one example, the message notifying that there is a departing participant can be “CCP Notify<Leave, ParticipantID>”.

Continuing with the description, in step S510, the conference control server/client 221 of the first terminal 220 may remove the departing second terminal 230 from the participant list in the first terminal 220. Then, in step S512, the conference control client 231 of the other second terminals 230 may remove the departing second terminal 230 from the participant lists in the other second terminals 230.

Next, in step S514, the floor control client 232 of the departing second terminal 230 that has received the conference service departure response message may conclude the peer connection with the mixer 212 of the conference server 210 for transmitting/receiving the media stream. Then, in step S516, the mixer 212 of the conference server 210 may re-perform the session negotiation with the floor control server 222 of the first terminal 220 and the floor control client 232 of the second terminal 230. Also, in step S518, the mixer 212 of the conference server 210 may conclude the peer connection with the departing second terminal 230; in step S520, the floor control server 222 of the first terminal 220 may remove the departing second terminal 230 from the list of participants transmitting media streams; and in step S522, the floor control clients 232 of the other second terminals 230 may remove the departing second terminal 230 from the list of participants transmitting media streams.

If the participant departing from the conference is the first terminal 220, the conference control server/client 221 of the departing first terminal 220 may transmit a conference service departure request message to the focus 211 of the conference server 210; the focus 211 of the conference server 210 may remove the departing first terminal 220 from the participant list of the conference server 210; the connection to at least one second terminal 230 participating in the conference may be concluded; and the conference being hosted by the conference server 210 may be removed.

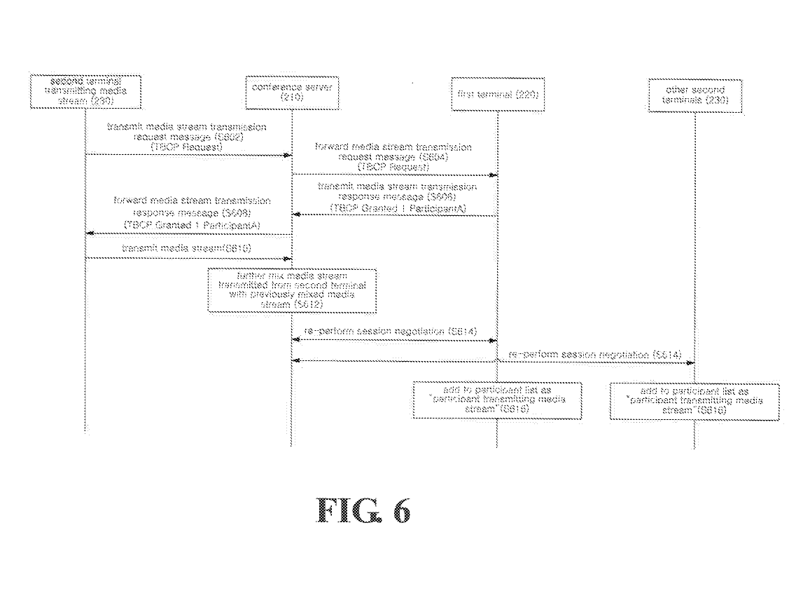

FIG. 6 is a flow diagram illustrating the flow of operations by which the second terminal 230 participating in a conference service in RTCWeb transmits a media stream according to an embodiment of the invention. The procedures performed for each operation will be described below in more detail.

First, in step S602, the floor control client 232 of the second terminal 230 transmitting a media stream may transmit a media stream transmission request message to the focus 211 of the conference server 210. In one example, the media stream transmission request message can be “TBCP (Talk Burst Control Protocol) Request”. Then, in step S604, the focus 211 of the conference server 210 may forward the media stream transmission request message to the floor control server 222 of the first terminal 220.

Continuing with the description, in step S606, the floor control server 222 of the first terminal 220 may transmit a media stream transmission response message to the focus 211 of the conference server 210 based on the media stream transmission request message. In one example, the media stream transmission response message can be “TBCP Granted 1 ParticipantA”. Then, in step S608, the focus 211 of the conference server 210 may forward the media stream transmission response message to the floor control client 232 of the second terminal 230 transmitting the media stream.

Next, in step S610, the floor control client 232 of the second terminal 230 transmitting the media stream may transmit a media stream to the mixer 212 of the conference server 210 based on the media stream transmission response message.

Afterwards, in step S612, the mixer 212 of the conference server 210 may further mix the media stream transmitted from the second terminal 230 with the previously mixed media stream. Then, in step S614, the mixer 212 of the conference server 210 may perform a session re-negotiation with the first terminal 220 and the other second terminals 230 participating in the conference service to transmit the further mixed media stream.

According to an embodiment of the invention, the session re-negotiation can be performed based on a trigger for activating the MediaStreamTrack of authorized participants. This trigger may be provided by a MediaStreamTrack object for a peer connection.

Lastly, in step S616, the floor control server 222 of the first terminal 220 and the floor control servers 232 of the other second terminals 230 may add the second terminal 230 transmitting the media streams to their respective participant lists as a “participant transmitting a media stream”.

However, if the first terminal 220 rejects the media stream transmission request, the floor control server/client 222 of the first terminal 220 may transmit a media stream transmission rejection message to the floor control client 232 of the second terminal 230 transmitting the media stream. In one example, the media stream transmission rejection message can be “TBCP Denied”.

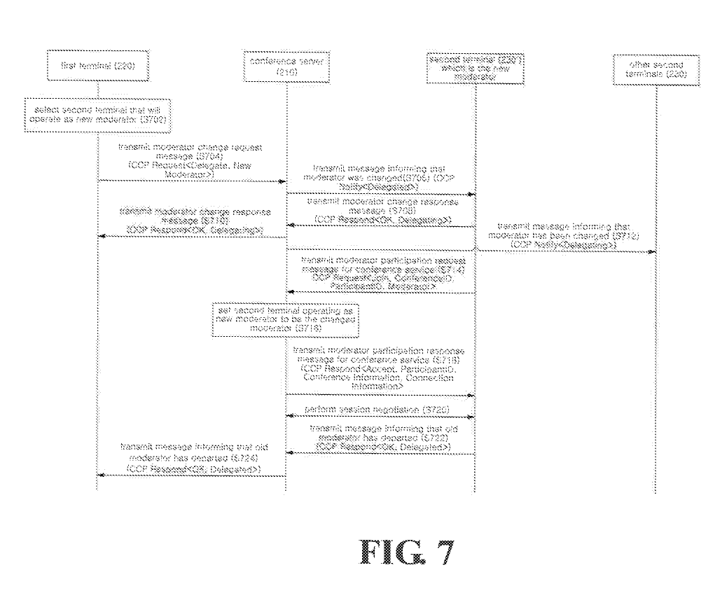

FIG. 7 is a flow diagram illustrating the flow of operations by which the first terminal 220 participating in a conference service in RTCWeb changes the moderator.

That is, referring to FIG. 7, a system for providing a conference service in RTCWeb may change the moderator from a first terminal 220 to a second terminal 230 that will operate as the new moderator. Here, the second terminal 230′ operating as the new moderator may include a conference control server/client 231′ instead of a conference control client 231 and a floor control server 232′ instead of the floor control client 232, similar to the first terminal 220.

The procedures performed for each step is described below in further detail.

First, in step S702, the conference control server/client 221 of the first terminal 220 may select the second terminal 230′ that will operate as the new moderator, from among the at least one second terminals 230. Then, in step S704, the conference control server/client 221 of the first terminal 220 may transmit a moderator change request message to the focus 211 of the conference server 210. Here, the moderator change request message may include identification information of the second terminal 230′ that is to be the new moderator. In one example, the moderator change request message transmitted from the first terminal 220 can be “CCP Request<Delegate, New Moderator>”. Afterwards, in step S706, the notification server 213 of the conference server 210 may transmit a message informing that the moderator was changed to the second terminal 230′ operating as the new moderator. In one example, the message informing that the moderator has been changed can be “CCP Notify<Delegated>”.

Next, in step S708, the conference control server/client 231′ of the second terminal 230′ operating as the new moderator may transmit a moderator change response message to the focus 211 of the conference server 210 based on the moderator change request message. In one example, the moderator change response message can be “CCP Respond<OK, Delegating>”. Then, in step S710, the focus 211 of the conference server 210 may transmit the moderator change response message to the conference control server/client 221 of the first terminal 220. Afterwards, in step S712, the notification server 213 of the conference server 210 may inform the other second terminals 230 participating in the conference service with a message informing that the moderator has been changed. In one example, the message informing that the moderator has been changed can be “CCP Notify<Delegating>”.

Continuing with the description, in step S714, the conference control server/client 231′ of the second terminal 230′ operating as the new moderator may transmit a moderator participation request message for the conference service. In one example, the moderator participation request message for the conference service can be “CCP Request<Join, ConferenceID, ParticipantID, Moderator>”. Afterwards, the focus 211 of the conference server 210, in step S716, may set the second terminal 230′ operating as the new moderator to be the changed moderator, and in step S718, may transmit a moderator participation response message for the conference service to the second terminal 230′ that is the changed moderator. In one example, the moderator participation response message for the conference service can be “CCP Respond<Accept, ParticipantID, Conference Information, Connection Information>”.

Next, in step S720, the mixer 212 of the conference server 210 and the floor control server 232′ of the second terminal 230′ that is the changed moderator may perform a session negotiation, and in step S722 and step S724, the second terminal 230′ that is the changed moderator may transmit a message through the conference server 210 to the first terminal 220, informing that the old moderator has departed. In one example, the message informing that the old moderator has departed can be “CCP Respond<OK, Delegated>”.

The technical features described above can be implemented in the form of program instructions that may be executed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

What is claimed is:

1. A conference server included in a system for providing a conference service in RTCWeb, the system comprising a first terminal and a second terminal, the first terminal operating as a moderator of the conference service and having a web browser executed thereon, the second terminal operating as a participant of the conference service and having a web browser executed thereon, the conference server comprising:
a focus configured to perform communication between the first terminal and the second terminal,
wherein the first terminal comprises a conference control server/client configured to control a generating of the conference, an adding/removing of the second terminal to/from the conference service, and a changing of a moderator, and configured to manage information of the second terminal,
the second terminal comprises a conference control client configured to acquire information of the conference service and configured to control a participation/departure in/from the conference service,
and the focus of the conference server communicates with the conference control server/client of the first terminal in order to resolve a request of the second terminal.

2. The conference server of claim 1, wherein the first terminal further comprises a floor control server for controlling a floor of the conference by granting/revoking authorization to transmit a media stream,
the second terminal further comprises a floor control client configured to communicate with the floor control server of the first terminal and request authorization to transmit a media stream or disengage a set floor,
and the conference server further comprises a mixer configured to mix media streams transmitted by the first terminal and the second terminal and transmit the mixed media stream to the first terminal and the second terminal.

3. The conference server of claim 2, wherein each of the first terminal and the second terminal further comprises a presence client configured to transmit presence information,
and the conference server further comprises a presence server configured to receive the presence information from each of the presence client of the first terminal and the presence client of the second terminal and to transmit the collected presence information to the presence client of the first terminal and the presence client of the second terminal.

4. The conference server of claim 3, wherein the conference server/client of the first terminal transmits a conference generation request message to the focus of the conference server, the conference generation request message containing information on a conference to be generated,
the focus of the conference server transmits a conference generation response message for a negotiation of the information on the conference to the conference control server/client of the first terminal based on the conference generation request message,
and if the conference control server/client of the first terminal agrees to the negotiation of the information on the conference, the conference control server/client of the first terminal transmits a negotiation agreement message for the conference generation to the focus of the conference server, and the focus of the conference server generates the conference based on the negotiation agreement message for the conference generation.

5. The conference server of claim 4, wherein the information on the conference includes at least one of identification information of the conference, a time at which the conference is generated, a time segment for informing that the second terminal can participate in the conference, a maximum number of the second terminals that can participate in the conference, a number of the second terminals participating in the conference, a maximum number of the second terminals that can transmit media simultaneously, a number of the second terminals transmitting media simultaneously, information on a predefined default presence, and a media codec.

6. The conference server of claim 5, wherein at least one of the time segment for informing availability for participating in the conference, the maximum number of the second terminals that can participate in the conference, the maximum number of the second terminals that can transmit media simultaneously, and the media codec, from among the information on the conference, is information of which negotiation is possible by the focus of the conference server and the conference control server/client of the first terminal.

7. The conference server of claim 2, wherein the conference server further comprises a notification server configured to notify information related to an event within the conference.

8. The conference server of claim 7, wherein the conference control client of the second terminal not participating in the conference service transmits a conference service participation request message to the focus of the conference server,
the focus of the conference server forwards the conference service participation request message to the conference control server/client of the first terminal if a codec exists that is capable of providing support between the mixer of the conference server and the non-participating second terminal,
the conference control server/client of the first terminal adds information of the non-participating second terminal to a participant list of the first terminal based on the conference service participation request message and transmits a conference service participation acceptance message to the focus of the conference server,
and the focus of the conference server adds the information of the non-participating second terminal to a participant list of the conference server to change the non-participating second terminal to a participated second terminal in the conference service and transmits the conference service participation acceptance message to the conference control client of the participated second terminal,
and the notification server of the conference server notifies others of the second terminals already participating in the conference service with a message informing that a new participant (the participated second terminal) has been added.

9. The conference server of claim 8, wherein the floor control client of the participated second terminal performs a session negotiation with the mixer of the conference server, and after the session negotiation is performed, the floor control client of the participated second terminal receives the mixed media stream from the mixer of the conference server.

10. The conference server of claim 7, wherein the conference control client of the second terminal departing from the conference service transmits a conference service departure request message to the focus of the conference server,
the focus of the conference server removes the departing second terminal from a participant list of the conference server based on the conference service departure request message and transmits a conference service departure response message to the conference control client of the departing second terminal,
the notification server of the conference server notifies the first terminal and others of the second terminals participating in the conference service with a message notifying that there is a departing participant (the departing second terminal),
the conference control server/client of the first terminal removes the departing second terminal from a participant list of the first terminal, and the conference control client of the other second terminals removes the departing second terminal from a participant list of the other second terminals.

11. The conference server of claim 10, wherein the floor control client of the departing second terminal, upon receiving the conference service departure response message, concludes a peer connection with the mixer of the conference server for transmitting/receiving the media stream,
and the mixer of the conference server re-performs the session negotiation with the floor control server of the first terminal and the floor control client of the second terminal.

12. The conference server of claim 7, wherein the floor control client of the second terminal transmitting a media stream transmits a media stream transmission request message to the focus of the conference server, the focus of the conference server forwards the media stream transmission request message to the floor control server of the first terminal,
the floor control server/client of the first terminal transmits a media stream transmission response message to the focus of the conference server based on the media stream transmission request message, the focus of the conference server forwards the media stream transmission response message to the floor control client of the second terminal transmitting the media stream,
the floor control client of the second terminal transmitting the media stream transmits a media stream to the mixer of the conference server based on the media stream transmission response message,
and the mixer of the conference server further mixes the media stream transmitted from the second terminal with the previously mixed media stream, and performs a session re-negotiation with the first terminal and others of the second terminals participating in the conference service to transmit the further mixed media stream.

13. The conference server of claim 7, wherein the system for providing a conference service in RTCWeb changes a moderator from the first terminal to the second terminal operating as a new moderator, the second terminal operating as the new moderator comprising a conference control server/client and a floor control server,
the conference control server/client of the first terminal transmits a moderator change request message to the focus of the conference server, the notification server of the conference server transmits a message informing that the moderator was changed to the second terminal operating as the new moderator,
the conference control server/client of the second terminal operating as the new moderator transmits a moderator change response message to the focus of the conference server based on the moderator change request message, the focus of the conference server transmits the moderator change response message to the conference control server/client of the first terminal, the notification server of the conference server informs others of the second terminals participating in the conference service with a message informing that the moderator has been changed,
the conference control server/client of the second terminal operating as the new moderator transmits a moderator participation request message for the conference service, the focus of the conference server sets the second terminal operating as the new moderator to be the changed moderator and transmits a moderator participation response message for the conference service to the second terminal that is the changed moderator,
the mixer of the conference server and the floor control server of the second terminal that is the changed moderator perform a session negotiation, and the second terminal that is the changed moderator transmits a message through the conference server to the first terminal, the message informing that the old moderator has departed.
